(19) United States
(12) Patent Application Publication
(10) Pub. No.: US 2024/0417552 A1
(43) Pub. Date: Dec. 19, 2024

(54) PURGING COMPOSITION

(71) Applicant: PREMIX OY, Rajamäki (FI)

(72) Inventors: Ville MYLLÄRI, Tampere (FI); Niko MERIVIRTA, Rajamäki (FI); Tuomas KIIKKA, Helsinki (FI)

(21) Appl. No.: 18/719,007

(22) PCT Filed: Dec. 15, 2022
(86) PCT No.: PCT/FI2022/050839

§ 371 Date: Jun. 12, 2024

(30) Foreign Application Priority Data
Dec. 17, 2021 (FI) 20216290

(51) Int. Cl. C08L 23/06; B29C 45/17; B29C 48/27; B29K 1/00; B29K 23/00; B29K 509/00; C08K 3/014; C08K 3/26

(52) U.S. Cl. CPC C08L 23/06; B29C 45/1753; B29C 48/27; C08K 3/014; B29K 2001/00; B29K 2023/0633; B29K 2509/00; B29K 2995/0041; C08K 2003/265; C08L 2207/066; C08L 2207/20

(57) ABSTRACT

The present disclosure relates to a purging composition for extrusion equipment, kneading equipment, mixing equipment, compounding equipment, or moulding equipment. The present disclosure further relates to a method for cleaning an extrusion or injection moulding machine or a mixer to removing a contaminant therefrom. Finally, the present disclosure relates to the use of a purging composition for cleaning equipment used for machining or handling materials such as plastics, polymeric materials, polymeric resins, paints, and unvulcanized rubber to remove a contaminant or residue therefrom.

### PRIOR RELATED APPLICATIONS

The present application is a National Entry of PCT Application No. PCT/FI2022/050839, filed on Dec. 15, 2022, which claims priority under the Paris Convention to Finnish Application No. FI 20216290, filed on Dec. 17, 2021. The entire contents of such prior applications are incorporated by reference herein.

### TECHNICAL FIELD

The present disclosure relates to a purging composition for extrusion equipment, kneading equipment, mixing equipment, compounding equipment, or moulding equipment. The present disclosure further relates to a method for cleaning an extrusion or injection moulding machine or a mixer to removing a contaminant therefrom. Finally, the present disclosure relates to the use of a purging composition for cleaning equipment used for machining or handling materials such as plastics, polymeric materials, polymeric resins, paints, and unvulcanized rubber to remove a contaminant or residue therefrom.

### BACKGROUND

In general, in resin manufacturing using an injection moulding equipment, cast film extrusion equipment, blown film extrusion equipment, profile extrusion equipment, compounding equipment, mixing equipment, or kneading equipment, the interior of the moulding machine may need to be cleaned. For example, when moulding is performed by changing the moulding material, a different type of moulding material that was moulded before the moulding material remains in the moulding machine, and thus when the changed moulding material is moulded by the moulding machine in this state, the residue in the moulding machine contaminates the post-modification moulding material as an impurity, reducing the quality of the obtained moulded product, or becoming a moulded product that does not conform to the quality specification. Therefore, cleaning in the moulding machine is performed when the moulding material is modified. In addition, even when the same moulding material is moulded continuously, a portion of the material remains in the moulding machine for a long time without being discharged from the moulding machine, but if the residence time is long, the material will be oxidized due to the thermal history during that time, and the oxidized material will remain in the moulding machine. When such an oxidized material is present in the moulding machine, the quality of the obtained moulded product is deteriorated in the same manner as described above. Thus, even when the same moulding material is continuously moulded, the inside of the moulding machine is cleaned at regular intervals.

Conventionally, cleaning in such a moulding machine was performed after disassembling the moulding machine, but disassembly of the moulding machine requires a large amount of time and effort, which significantly reduces productivity. In recent years, the development of cleaning agents capable of cleaning the inside of a moulding machine simply by introducing the agents into the moulding machine and performing normal moulding operations without disassembling the moulding machine has been advanced.

### SUMMARY

A purging composition for extrusion equipment, kneading equipment, mixing equipment, compounding equipment, or moulding equipment is disclosed. The purging composition may comprise a polymer and microcellulose.

A method for cleaning kneading equipment, mixing equipment, compounding equipment, or moulding equipment is also disclosed. The method may comprise passing a purging composition according to the present disclosure through the equipment.

Finally, the use of a purging composition according to the present disclosure for cleaning equipment used for machining or handling materials such as plastics, polymeric materials, polymeric resins, paints, and unvulcanized rubber to remove a contaminant or residue therefrom is disclosed.

### DETAILED DESCRIPTION

A purging composition for extrusion and injection moulding, such as extrusion equipment, kneading equipment, mixing equipment, compounding equipment, melt spinning equipment or moulding equipment, is disclosed. The purging composition comprises a polymer and microcellulose comprising microcrystalline cellulose (MCC).

As used in this specification, the term “microcellulose” includes microcrystalline cellulose (MCC) but also refers to similar products which are not totally crystalline but may contain some amorphous regions. The microcellulose of the present invention typically has a hemicellulose content of about 0% to 15% by weight, preferably 0.5% to 8% by weight, more preferably 1% to 5% by weight measured by typical carbohydrate analysis methods known to a person skilled in the art. In one embodiment, the microcellulose is added in a solid form, e.g. powder, flake, floccule or pellet, to the purging composition. In one embodiment, the microcellulose is in a powder form.

A purging composition according to the present disclosure may be used for purging equipment used for machining or handling materials such as plastics, polymeric materials, polymeric resins, paints, and unvulcanized rubber.

In certain embodiments, the equipment may be extruder equipment, kneading equipment, mixing equipment, compounding equipment, moulding equipment, or any combination thereof. In certain embodiments, the equipment may be injection moulding equipment, extruders, melt spinning equipment, or any combination thereof. The function of the purging composition is to mechanically remove contaminants and material residues from the equipment that is cleaned.

The microcellulose contains at least microcrystalline cellulose (MCC). In one embodiment, the microcellulose consists of microcrystalline cellulose (MCC). In one embodiment, the microcellulose is microcrystalline cellulose (MCC).

In certain embodiments, the MCC has a particle size of 1-500 μm.

Compared to traditional purging compositions, the inclusion of microcellulose in the composition is advantageous, among other reasons, as it enables the use of biobased, renewable raw materials. The inclusion of the microcellulose also provides a purging composition that includes smaller amount of hard mineral particles and thereby poses less risk of harming the surfaces of the equipment to be cleaned e.g. by scratching them.

In certain embodiments, the purging composition comprises a polyolefin, polyester, polyether, polyamide, polycarbonate, polyurethane, or any combination thereof.

In certain embodiments, the composition comprises polyethylene, polypropylene, polybutylene, polystyrene, acrylonitrile butadiene styrene, polybutadiene terephthalate, polyethylene terephthalate, polyamide, polycarbonate, polylactic acid, styrene-acrylonitrile, thermoplastic elastomer, thermoplastic polyurethane, thermoplastic starch, polybutylene succinate, polyhydroxyalkanoates, polyhydroxyburyrate, polybutylene adipate terephthalate.

In certain embodiments, the composition comprises polyethylene or polypropylene, or their copolymers with acrylic monomers.

In certain embodiments, the composition comprises polyethylene or polypropylene.

In certain embodiment, the composition comprises biobased polyethylene or polypropylene, or their copolymers with acrylic monomers.

In certain embodiment, the composition comprises biobased polyethylene or polypropylene.

In certain embodiments, the composition comprises biodegradable polylactide.

In certain embodiments, the amount of polymer in the composition is 15-95%, or 30-85%, or 30-80%, or 50-85%, or 40-60% by weight.

In certain embodiments, the composition comprises microcellulose in an amount that is 1-80%, or 10-50%, or 18-38%, or 20-35% by weight.

In certain embodiments, the microcellulose comprises 0-15%, or 0.5-8%, or 1-5%, or 0.5-3 by weight hemicellulose. In certain embodiments, the microcellulose comprises less than 5%, or less than 3%, or less than 2% by weight hemicellulose.

In certain embodiments, the microcellulose comprises microcrystalline cellulose over 95% by weight, or over 97% by weight, or over 98% by weight, or over 99% by weight.

The low amount of hemicellulose included in the MCC is advantageous as it improves the heat resistance of the purging composition. Once materials that are degraded in low temperatures such as lignin and hemicellulose have been removed, microcellulose has a heat tolerance (i.e. it does not degrade, start smoking, etc.) that is higher than that of other comparable biomaterials.

In certain embodiments, using microcellulose and specifically MCC is advantageous compared to using e.g. hemicellulose as the crystals of MCC are sharp and needle-like, meaning that they are efficient at scraping various residues from surfaces.

In certain embodiments, the composition comprises a mineral filler, stabilizer, release agent, and/or other additives.

In certain embodiments, the mineral filler is selected from the group consisting of materials with a hardness of 5 or less on Mohs scale of mineral hardness.

In certain embodiments, the mineral filler is selected from the group consisting of gypsum, calcium carbonate, kaolin, talc, aluminium trihydrate, mica, barium sulphate, clay, or any combination thereof. In one embodiment, the mineral filler is calcium carbonate.

In certain embodiments, the composition comprises as a stabilizer a phenolic primary antioxidant, a phosphite-based secondary antioxidant, or any combinations thereof. Non-limiting examples of commercially available antioxidants suitable for use in a composition according to the present disclosure are Irganox 1010 and Irgafox 168.

In one embodiment, the purging composition may comprise approximately 50% by weight polymer, approximately 25% by weight microcellulose, and approximately 25% by weight mineral filler. In one embodiment, the purging composition may comprise 75-85%, e.g. approximately 80%, by weight polymer, and 15-25%, e.g. approximately 20%, by weight microcellulose.

In certain embodiments, the composition comprises as a release agent a metal stearate, an organic acid, or a combination thereof.

The function of the release agent is to avoid unwanted adhesion of the purging agent with e.g. metal parts like moulds in injection moulding.

In certain embodiments, the composition comprises, as a release agent, zinc stearate, calcium stearate, oleamide, erucylamide, or any combination thereof.

In certain embodiments, the purging composition is in the form of granules, a powder, or any free flowing form. In one embodiment, the purging composition is in the form of plastic granules or a powder.

In certain embodiments, the purging composition is manufactured using a mixing device, a screw compounder, e.g. a twin screw compounder, or other suitable device. In one embodiment, the purging composition is manufactured by melting the composition with a processing melt temperature, e.g. temperature of 150-230° C. In one embodiment, the composition is pelletized after mixing or compounding, e.g. in a pelletizer, to form granules. In one embodiment, compounded granules are dried, e.g. using centrifugal drier and/or dry air dryer.

A method for cleaning extrusion equipment, kneading equipment, mixing equipment, compounding equipment, melt spinning equipment, or moulding equipment to remove a contaminant therefrom is disclosed herein. The method may comprise the step of passing a purging composition according to present disclosure through the equipment. In certain embodiments, the equipment is an extrusion moulding machine, an injection moulding machine, a compounding machine, a powder paint mixer, a kneader, melt mixing equipment, melt spinning equipment, or any combination thereof.

The use of a purging composition according to the present disclosure for cleaning an extrusion or injection moulding machine or a mixer to remove a contaminant therefrom is disclosed herein.

In certain embodiments, a purging composition according to the present disclosure may be used to clean or purge equipment used for machining or handling materials such as plastics, polymeric materials, polymeric resins, paints, and unvulcanized rubber. In certain embodiments, the equipment may be injection moulding equipment, extruders, melt spinning equipment, or any combination thereof. The function of the purging composition is to mechanically remove contaminants and material residues from the equipment that is cleaned.

The purging composition described in the current specification has the added utility of having properties suitable for efficiently cleaning or purging equipment such as injection moulding equipment, extruders, melt spinning equipment, or any combination thereof. The purging composition of the present disclosure is additionally manufactured using biobased, renewable raw materials and also poses less risk of harming the surfaces of the equipment to be cleaned e.g. by scratching them while simultaneously efficiently cleaning or purging the equipment.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1

The composition of the compounds contains 50% recycled low density polyethylene (MFI 5 g/10 min, 190° C., 2.16 kg), 25% microcrystalline cellulose (JRS, Heweten 101), and 25% Calcium carbonate (Omya, Omyacarb 2-GU).

The composition is manufactured using a twin screw compounder with a processing melt temperature of 190° C. and underwater pelletizer. The screw geometry is chosen to be suitable for sensitive materials so that fibres, that are fed through a side feeder into the compounder at the end section of it, are not destroyed during the compounding. Compounded granules are first dried using centrifugal drier and further dried using dry air dryer (6 h, 80° C.).

These granules (MFI 0.5 g/10 min, 190° C., 5 kg) can then be used to clean extrusion or injection moulding machines.

### Example 2

The composition is used to purge blown film extruders so that during the changeover the bubble is up. With most known purging compounds, the bubble needs to be taken down during purging.

The composition of the compounds contains 80% of low-density polyethylene (Borealis FA5224, MFI 1.2 g/10 min, 190° C., 2.16 kg) and 20% of microcrystalline cellulose (JRS, Heweten 101).

The composition is manufactured using a twin screw compounder with a processing melt temperature of 190° C. and underwater pelletizer. The screw geometry is chosen to be suitable for sensitive materials so that fibers, that are fed through a side feeder into the compounder at the end section of it, are not destroyed during the compounding. Compounded granules are first dried using centrifugal drier and further dried using dry air dryer (6 h, 80° C.).

These granules (MFI 0.4 g/10 min, 190° C., 2.16 kg) can then be used to clean blown film extrusion or other plastic processing machines.

### Example 3

The composition is used to purge not only commodity plastics, e.g. polyethylene, polypropylene, polystyrene, ethylene vinyl acetate or thermoplastic elastomers, but also technical plastics, e.g. acrylonitrile butadiene styrene, polycarbonate, polyamide or polyacetal, due to the improved processing temperature. Most known biomaterials can withstand only roughly 200° C., but highly pure microcrystalline cellulose used in this composition has a thermal degradation onset temperature of nearly 300° C. according to TGA testing.

The composition of the compounds contains 50% of high-density polyethylene (ExxonMobil HDPE HYA800, MFI 0.7 g/10 min, 190° C., 2.16 kg), 25% of microcrystalline cellulose (DuPont, Avicel PH-101), and 25% of calcium carbonate (Omya, Omyacarb 2-GU).

The composition is manufactured using a twin screw compounder with a processing melt temperature of 210° C. and underwater pelletizer. The screw geometry is chosen to be suitable for sensitive materials so that fibers, that are fed through a side feeder into the compounder at the end section of it, are not destroyed during the compounding. Compounded granules are first dried using centrifugal drier and further dried using dry air dryer (6 h, 80° C.).

These granules (MFI 0.6 g/10 min, 190° C., 5 kg) can then be used to clean extrusion or injection moulding machines.

It is obvious to a person skilled in the art that with the advancement of technology, the basic idea may be implemented in various ways. The embodiments are thus not limited to the examples described above; instead, they may vary within the scope of the claims.

The embodiments described hereinbefore may be used in any combination with each other. Several of the embodiments may be combined together to form a further embodiment. A composition, a method, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A purging composition for extrusion equipment, kneading equipment, mixing equipment, compounding equipment, melt spinning equipment, or moulding equipment, characterized in that the purging composition comprises a polymer and microcellulose which comprises microcrystalline cellulose (MCC).

2. The purging composition of claim 1, wherein the microcellulose is microcrystalline cellulose (MCC).

3. The purging composition of claim 1 wherein the composition comprises a polyolefin, polyester, polyether, polyamide, polycarbonate, polyurethane, polybutylene, polystyrene, acrylonitrile butadiene styrene, polybutadiene terephthalate, polyethylene terephthalate, polyamide, polycarbonate, polylactic acid, styrene-acrylonitrile, thermoplastic elastomer, thermoplastic polyurethane, thermoplastic starch, polybutylene succinate, polyhydroxyalkanoates, polyhydroxyburyrate, polybutylene adipate terephthalate, or any combination thereof.

4. The purging composition of claim 1, wherein the composition comprises polyethylene, polypropylene or their copolymers with acrylic monomers.

5. The purging composition of claim 1, wherein the amount of polymer in the composition is 15-95%, or 30-85%, or 40-60% by weight.

6. The purging composition of claim 1, wherein the composition comprises MCC in an amount that is 1-80%, or 10-50%, or 18-38%, or 20-35% by weight.

7. The purging composition of claim 1, wherein the MCC comprises 0-15%, or 0.5-8%, or 1-5% by weight hemicellulose.

8. The purging composition of claim 1, wherein the composition comprises a mineral filler, stabilizer, release agent, and/or other additives.

9. The purging composition of claim 1, wherein the mineral filler is selected from the group consisting of materials with a hardness of 5 or less on Mohs scale of mineral hardness.

10. The purging composition of claim 1, wherein the mineral filler is selected from the group consisting of gypsum, calcium carbonate, kaolin, talc, aluminium trihydrate, mica, barium sulphate, clay, or any combination thereof.

11. The purging composition of claim 1, wherein the composition comprises as a stabilizer a phenolic primary antioxidant, a phosphite-based secondary antioxidant, or any combinations thereof.

12. The purging composition of claim 1, wherein the composition comprises as a release agent a metal stearate, an organic acid, or a combination thereof.

13. The purging composition of claim 1, wherein the composition comprises zinc stearate, calcium stearate, oleamide, erucylmide, or any combination thereof.

14. The purging composition of claim 1, wherein the purging composition is in the form of granules, a powder, or any free flowing form.

15. A method for cleaning extrusion equipment, kneading equipment, mixing equipment, compounding equipment, or moulding equipment to remove a contaminant therefrom, comprising the step of passing a purging composition according to claim 1 through the machine.

16. The method of claim 15, wherein the equipment is an extrusion moulding machine, an injection moulding machine, a compounding machine, a powder paint mixer, a kneader, melt mixing equipment, melt spinning equipment, or any combination thereof.

17. Use of a purging composition according to claim 1 for cleaning equipment used for machining or handling materials such as plastics, polymeric materials, polymeric resins, paints, and unvulcanized rubber to remove a contaminant or residue therefrom.

18. The use of claim 17, wherein the equipment is an extrusion or injection moulding machine, a mixer, or melt spinning equipment to remove a contaminant therefrom.
